(19) United States
(12) Patent Application Publication
(10) Pub. No.: US 2004/0056643 A1
(43) Pub. Date: Mar. 25, 2004

(54) Method of determining the output capacitance of a voltage supply device

(76) Inventors: Christoph Loef, Aachen (DE); Christian Hattrup, Herzogenrath (DE); Thorsten Gercke, Hamburg (DE)

Correspondence Address: PHILIPS INTELLECTUAL PROPERTY & STANDARDS, P.O. BOX 3001, BRIARCLIFF MANOR, NY, 10510, US

(21) Appl. No.: 10/144,823

(22) Filed: Oct. 25, 2001

(30) Foreign Application Priority Data
Oct. 27, 2000 (DE) 10053279.9

(51) Int. Cl. G05F 1/40

(52) U.S. Cl. 323/288

(57) ABSTRACT

The invention relates to a method of determining the output capacitance of a voltage supply device, as well as a voltage supply device and an X-ray apparatus. To determine the output capacitance of a voltage supply device in a simple manner, a measuring method is proposed in which an output voltage of a predefined first measuring voltage value is generated and, subsequently, the voltage supply is turned off, so that the output capacitance is discharged through at least one precision resistor provided in the voltage supply device, the output capacitance being calculated from the discharge curve.

The invention relates to a method of determining the output capacitance of a voltage supply device, as well as the voltage supply device and an X-ray apparatus including a voltage supply device.

Voltage supply devices are used for supplying electric energy to consumers, a voltage supply device normally comprising at least two output terminals and delivering between these output terminals a defined controlled or uncontrolled supply voltage for the connected consumers.

More particularly high-voltage supply devices are often arranged as switched-mode power supplies. They take the electric energy from the mains and convert this energy into the voltage values necessary for the consumers to operate. For example, a high-voltage supply for an X-ray tube is to deliver voltages in the range from 40 kV to 150 kV and currents up to 1.3 A, while the tube voltage is controlled to the necessary target value by means of a controller.

Especially with voltage supply devices in which the output voltage is controlled by a control, an important parameter is the output capacitance of the voltage supply device. This parameter plays a special role when a high-voltage supply device is arranged as a resonant circuit. For an optimal control of the output voltage, this parameter is to be taken into account.

The value of the output capacitance strongly depends on the wiring of the voltage supply device. More particularly cable capacitances play a role here.

This used to be taken into account in the past for high-voltage supplies for X-ray tubes, in that, according to an empirical formula based on the cable length, an estimate was determined for the output capacitance and taken into account for the control. This method, however, is time-consuming for the operating staff and gives a rather inaccurate result.

Therefore, it is an object of the invention to improve the known method and devices, more particularly also X-ray apparatuses, so that the output capacitance can be determined in a simple manner.

This object is achieved by a method as claimed in claim 1, a voltage supply device as claimed in claim 9 and an X-ray apparatus as claimed in claim 12. Dependent claims relate to advantageous embodiments.

According to the invention the output capacitance of the voltage supply device is determined in that an output discharge curve is generated and the value of the output capacitance is determined based on the course of the discharge curve.

The output capacitance has the advantage that—contrary to the estimate of the capacitance based on the cable length—all the parasitic capacitances are taken into account for the measurement and thus a really accurate value is determined.

According to the invention a discharge curve is generated in that the voltage supply first generates an output voltage to which the output capacitor is charged, and this output capacitor is then discharged via the RC element which comprises an output capacitor and a precision resistor. In the simplest case, the voltage generated first (first measuring voltage value) is turned off for this purpose; a discharge curve, however, is obviously also formed when the voltage is merely switched down to a smaller value.

It should be noticed that the timing of the measurement is selected so that always only steady states are taken into account and no transients affect the measurement.

Determining the output capacitance from the course of the discharge curve is preferably effected in that measuring values of the voltage between the output terminals at different points of time are recorded. In the simplest case only two measuring values are necessary here. One of these measuring values may be, in principle, the first measuring voltage value (to which the output capacitor is charged at the beginning of the measurement). To obtain a better accuracy, however, the first measurement is preferred to be made only after a waiting period after the voltage supply has been switched off.

Based on the mathematically known course of the resistive discharge of the capacitor U(t)=U_{begin}e^{-t/RC}, the capacitance value can already unambiguously be determined from two voltage measurements at known instants. However, for this purpose the value of the precision resistor is to be known most accurately.

According to a further embodiment of the invention, the measurement is made based on two predefined voltage values, one initial voltage value and one final voltage value. By continuously measuring the output voltage, there is first determined when the output voltage has dropped to the initial voltage value. Then a further measurement is made until the final voltage value has been reached. With the known precision resistor R and fixed initial and final voltage values U_{A} and U_{B}, the capacitance C can be calculated in a very simple manner. The capacitance C is proportional to the time difference.

As an alternative, it is also possible that two instants (preferably after a delay) are determined at which the voltage is measured and the capacitance is calculated via the mathematically known course of the curve. However, due to the necessary logarithmic calculation this is very expensive.

As already observed, the exact knowledge of the value of the precision resistor also influences the exactness of the measurement of the capacitance. In high-voltage supply devices, more particularly for X-ray tubes, there are always highly accurate resistors (deviation below 1%) as voltage dividers. Because normally only part of the high voltage generated by the voltage supply device is measured. It is now particularly advantageous that both the voltage dividers provided in many high-voltage supply devices and the voltage measuring devices also already provided are used for determining the output capacitance. Thus no additional circuitry or introduction of measuring devices is necessary. The measurement can rather be effected fully automatically by the device, with a controller accordingly controlling the voltage supply device. Such a controller may be, for example, an arbitrary means known to the expert, for example, a microprocessor controller.

Voltage supply devices customarily comprise connection devices for a consumer, more particularly, plug and cable. It is particularly advantageous to carry out the measuring method according to the invention when the connection devices are connected. More particularly connected cables decisively influence the sought output capacitance via their cable capacitance.

It is extremely favorable when the voltage can be measured even with a connected consumer. A distortion of the measurement by the consumer is then, however, either to be precluded or to be proved by calculations. When the consumer is an X-ray tube, this may be achieved in that the heat path of the tube is currentless, so that no current can flow inside the tube. In practice, however, it should be borne in mind that—even without a cathode heating—electrode emission (field emission) may occur in the event of high-voltage values. The expert will bear in mind that the measurement is made at voltages for which no disturbing field emission takes place.

An X-ray apparatus according to the invention comprises at least one X-ray tube and one voltage supply device with a device for automatically determining the output capacitance. Especially with an X-ray apparatus, it is very important to determine the output capacitance exactly for the necessary highly accurate output voltage controller.

This is particularly the case with an arrangement in which a central voltage supply device supplies power to a plurality of X-ray tubes via cables. Depending on cable length, arrangement etc., the output capacitances are distinguished depending on which X-ray tube is currently driven. For example, after each change-over or each time before the X-ray tube is switched on, an automatic measurement may be made of the output capacitance, so that the controller receives the correct value of the output capacitance as a parameter for the voltage supply.

These and other aspects of the invention are apparent from and will be elucidated with reference to the embodiments described hereinafter.

In the drawings:

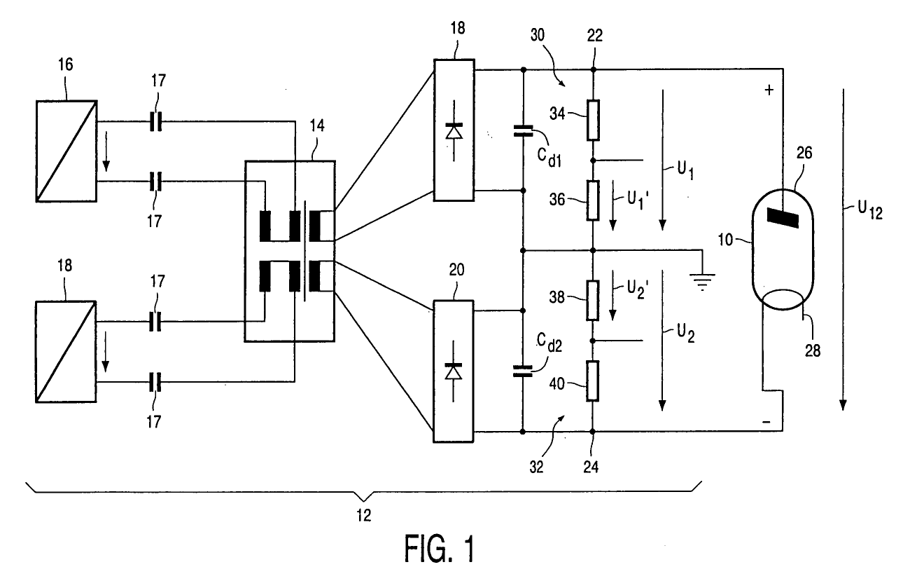

FIG. 1 shows a circuit diagram of a high-voltage supply for an X-ray tube;

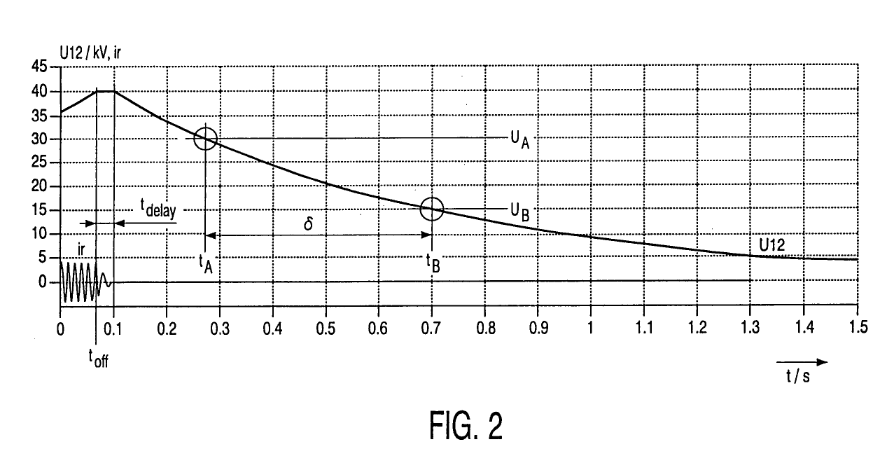

FIG. 2 shows a diagram of the discharge curve of the output capacitance via a precision resistor.

FIG. 1 shows a circuit for an X-ray apparatus comprising an X-ray tube 10 and a voltage supply circuit 12. The voltage supply circuit 12 is structured as a load-resonant inverter. It comprises a transformer 14 to whose primary side the two inverters 16, 18 are connected. To the secondary side of the transformer 14 are connected the rectifier bridges 18, 20 whose output terminals 22, 24 are connected, on the one hand, to the anode 26 or cathode 28 respectively, of the X-ray tube 10 and, on the other hand, to ground.

The high voltage U₁₂ between the output terminals 22, 24 is generated in the following way: the inverters 16, 18 run in synchronism and, powered by the mains voltage (not shown), deliver the voltages U₁ and U₂, respectively, to the primary side of the transformer 14. Inside the transformer 14 the low input voltage is transformed into a high voltage. The secondary side of the high-voltage transformer 14 has four taps and each of the rectifier bridges 18, 20 is connected to two taps. The secondary side output AC voltage (high voltage) of the transformer 14 is rectified by the rectifier bridges 18, 20. Their output voltages U₁, U₂ are symmetrical relative to ground potential i.e. the anode voltage U₁ has the same voltage value relative to ground potential as the cathode voltage U₂.

Between the output terminals 22, 24 and ground potential are connected the voltage dividers 30, 32 formed by the precision resistors 34, 36, 38, 40. The voltage dividers 30, 32 are used for dividing the anode voltage U₁ or cathode voltage U₂, respectively, down to the clearly lower voltages U′₁ and U′₂. The resistors satisfy strict accuracy requirements; they have a deviation of less than 1%.

Between the output terminals 22, 24 and ground potential in the circuit diagram are also shown the output capacitances C_{d1} and C_{d2}. In practice they are not discrete components. But these capacitors act as parasitic capacitors, particularly as cable capacitors of the connection cable by which the X-ray tube 10 is connected to the voltage supply circuit 12 (not shown). In the voltage supply circuit 12 the capacitances C_{d1} and C_{d2} act as buffer capacitances for the output voltages U₁, U₂.

As already observed, the voltage supply circuit 12 all in all works as a load-resonant inverter. The primary circuit is then complemented to a series resonant circuit by the stray inductance of the transformer 14 and resonant capacitors 17. The secondary-side winding capacitance of the high-voltage transformer 14 extends the load circuit to a series-parallel resonant circuit. The operating frequency of the synchronized inverter 16, 18 is selected such that it is in the neighborhood of the Eigenresonant frequency of the load circuit. This minimizes the voltage drop of the impedance of the resonant circuit.

The voltage supply circuit 12 comprising two inverters 16, 18 and two rectifier bridges 18, 20, which are symmetrical with ground potential, is obviously not forcibly the only possible structure of such a circuit. Depending on requirements, there may also be either one inverter and/or only one rectifier bridge In this case the primary side and/or secondary side of the circuit shown in FIG. 1 has only one of the identical upper or lower parts of the circuit.

When the X-ray apparatus is in operation, it is necessary to have a very fast and accurate control of the high voltage U₁₂ between anode 26 and cathode 28 of the X-ray tube 10. When the X-ray tube is driven for making an X-ray picture in the medical field, for example a requirement is that the rise time (i.e. the time between reaching 10% and reaching 90% of the nominal voltage).is to be less than a millisecond. Because the X-rays which are generated at lower voltages do not enhance the picture quality, but only increase the radiation load of the patient.

For this reason a very fast and extremely accurate control is used, which controls the inverters 16, 18 so that the desired voltage U₁₂ is generated on the output side. For this control the measured voltages U′₁ and U′₂ i.e. the divided parts of the anode or cathode voltage respectively, form the controlled variable. An important parameter for this control is the magnitude of the capacitances C_{d1} and C_{d2}.

For determining these capacitances, the automatic measuring method described in the following is used, which comprises the following steps:

activating the voltage supply circuit 12, so that output voltage U₁₂ is generated having a measuring voltage value of, for example, 40 kV,

switching off the inverter, so that no further voltage supply takes place and the output capacitors C_{d1} and C_{d2} are discharged via the precision resistors 34, 36, 38, 40, which output capacitors were charged up to the measuring voltage value (40 kV),

observing the discharge curve by measuring the voltages U₁ and U₂ (measurement of the divided voltages U′₁ and U′₂) at different instants.

determining the capacitances C_{d1} and C_{d2} (from the measured values).

The procedure of the measuring method will now be explained in detail with reference to the discharge curve shown in FIG. 2.

First the inverters 16, 18 are triggered so that on the output side a voltage U₁₂ of about 40 kV is set. The accuracy with which this first measuring voltage value is reached is not critical, because the actual measurement does not take place until the middle area of the discharge curve. After the further voltage supply has been switched off at instant t-t_{off}, first a period of time t_{delay} is waited for until parasitic oscillations on the primary and secondary sides of the transformer 14 have died away. Only after this period of time is it ensured that no further energy is applied to the output circuit. The capacitors C_{d1} and C_{d2} are now charged to the symmetrical voltages U₁ and U₂ of respectively U₁₂/2=approximately 20 kV and discharged via the resistors 34, 36, 38, 40 of the voltage dividers 30, 32.

For the further course of the measurements, the voltage U₁₂ is measured continuously while an initial voltage value U_{A} and a final voltage value U_{B} are predefined which are sufficiently different and are both below the first measuring voltage value of 40 kV. U_{A} is then greater than U_{B}. Preferably, the values are chosen such that they are in the range from 10% to 90% of the maximum voltage of the discharge curve. In practice, the expert will bear in mind when choosing U_{B} and U_{A} that the measurement is evaluated by a signal processor controller. This signal processor must be capable of processing the measurements sufficiently fast. Since, however, the time distance between the measuring points U_{A} and U_{B} depends on the capacitance C (the distance being only very short when C is very low), it is to be ensured that for all capacitances C to be expected the measurement can still be made and processed.

During the continuous measurement, a moving average is calculated of the voltage value U₁₂ via a digital filter, so that disturbances can be filtered out and the measurement is unaffected by them. In practice, an average determined over 8 measuring values has proved to be reliable. During the continuous measurement the instants t_{A} and t_{B} are taken at which the voltage U₁₂ reaches or falls short of respectively, the predefined initial or final voltage values U_{A} and U_{B}. The time difference δ results from δ=t_{B}-t_{A}.

The capacitance is calculated from this while the generally known function which describes the resistive discharge of a capacitor is used:

$${U}_{B} = {U}_{A} {ⅇ}^{\frac{- δ}{τ}} ( 1.0 ) with τ = R \cdot C . \qquad ( 1.1 )$$

This leads to

$$⇒ \frac{{U}_{B}}{{U}_{A}} = {ⅇ}^{\frac{- δ}{τ}} ( 2.1 ) ⇒ In ( \frac{{U}_{B}}{{U}_{A}} ) = \frac{- δ}{R \cdot C} . \qquad ( 2.2 )$$

This can be resolved according to the capacitance value C into

$$C = \frac{δ}{In ( \frac{{U}_{A}}{{U}_{B}} ) \cdot R} . \qquad ( 2.3 )$$

Since the magnitude of the discharge resistor R is known and the initial and final voltage values U_{A}, U_{B} are also fixed, the denominator in (2,3) corresponds to a constant

$$K = In ( \frac{{U}_{A}}{{U}_{B}} ) \cdot R , \qquad ( 3.2 )$$

so that the capacitance C is proportional to the time difference δ

$$C = \frac{δ}{K} . \qquad ( 3.1 )$$

While the sum of the capacitances C_{d1} and C_{d2} is determined by the method described above, which starts from the discharge curve for U₁₂, the measuring method can be carried out separately for the anode-side capacitor C_{d1} and the cathode-side capacitor C_{d2} by separately measuring the voltages U₁ and U₂, so that these capacitances and their deviation allow to be determined separately of each other.

The X-ray apparatus whose current supply circuit 12 is shown in FIG. 1 includes a controller (not shown) which performs this measurement automatically. The controller also triggers the heating cathode of the X-ray tube 10. When a capacitance is measured, the cathode 28 of the X-ray tube 10 is unheated so that no electrodes come out and no current flows inside the tube 10 either. In this way the measurement is carried out when the tube is connected and all the terminal and cable capacitances can be taken into account in this manner.

The controller of the X-ray apparatus is a microprocessor controller which is also coupled to the measuring arrangement (not shown either) for the voltages U′₁ and U′₂. Since the regulator of the X-ray apparatus is digitally implemented in this microprocessor controller and as such triggers the inverters 16, 18 and also evaluates the voltage measuring values U′₁ and U′₂, also the control of the automatic measuring method can be simply taken over by the microprocessor controller.

A program running on this controller takes over the respective triggering of the voltage supply circuit 12 and the evaluation of the voltage measurements U′₁ and U′₂ in that the value for the time difference δ is determined as described above. Since the magnitude of the resistors 34, 36, 38, 40 is fixed and known for a certain apparatus, and since also the initial and final voltage value U_{A}, U_{B} is fixed for each apparatus, the calculation of the capacitance C is limited to the division δ/K or (numerically more advantageously) the multiplication by the inverse value of K, respectively.

In a second embodiment (not shown) a voltage supply circuit 12 supplies power to various X-ray tubes. The X-ray tubes are then coupled to the voltage supply circuit 12 by cables of different lengths. Each time one of the X-ray tubes is selected via a change-over switch and connected to the output terminals 22, 24.

In the second embodiment the value for the capacitors C_{d1} and C_{d2} varies depending on the connected X-ray tube. Therefore, an automatic capacitance measurement is made at least after every change of the configuration.

1. A method of determining the output capacitance of a voltage supply device (12) in which an output voltage (U₁₂) having a predefined first measuring voltage value is generated and then the voltage supply is switched off or switched down to a smaller second measuring voltage value, so that the output capacitance (C_{d1}, C_{d2}) is discharged through via at least one precision resistor (34, 36, 38, 40) provided in the voltage supply device, while the capacitance of the output capacitor (C_{d1}, C_{d2}) is determined from the discharge curve.

2. A method as claimed in claim 1, in which the capacitance is determined automatically while a controller accordingly controls the voltage supply device (12) and controls the measuring device, so that measuring values of the discharge curve are recorded, and determines the capacitance (C_{d1}, Cd2) from the recorded measuring values.

3. A method as claimed in claim 1 or 2, in which the capacitance of the output capacitor (C_{d1}, C_{d2}) is determined from the discharge curve, in that the time difference (δ) between the reaching or falling short of a predefined initial voltage value (U_{A}) and the reaching or falling short of a predefined final voltage value (U_{B}) is measured, and the capacitance value is calculated from the time difference (δ), the initial voltage value (U_{A}), the final voltage value (U_{B}) and the resistance value of the precision resistor or of the precision resistors (34, 36, 38, 40).

4. A method as claimed in claim 1 or 2, in which the output capacitance (C_{d1}, C_{d2}) is determined from the discharge curve, in that at at least two fixed instants the output voltage is measured and the voltage difference is determined and the capacitance value is calculated from the voltage difference, from the at least two measuring points and the resistance value of the precision resistor or the precision resistors (34, 36, 38, 40).

5. A method as claimed in one of the preceding claims, in which the measurement does not begin until a predefined waiting time (t_{delay}) has elapsed after the voltage supply has been switched off.

6. A method as claimed in one of the preceding claims, in which the capacitance is determined while a connection device, particularly plug and/or cable, is coupled for the connection of a load to the voltage supply device (12).

7. A method as claimed in one of the preceding claims, in which the precision resistors through which the voltage is discharged form at least a voltage divider (30, 32) comprising at least two resistors (34, 36; 38, 40) and the divided voltage (U′₁, U′₂) is measured by at least one of the resistors (36, 38) of the voltage divider (30, 32).

8. A method as claimed in one of the claims 1 to 7, of determining the output capacitance of a high-voltage supply device for an X-ray tube (10), in which the X-ray tube (10) is connected to the high-voltage supply (12) during the measurement, but during which measurement no current flows through the tube (10).

9. A voltage supply device comprising a voltage supply unit, more particularly, a high-voltage supply unit (12) having at least two output terminals (22, 24) and at least one precision resistor (34, 36, 38, 40) which is connected between the output terminals (22, 24), characterized by a device for automatically determining the output capacitance, the output capacitance determining device comprising a voltage measuring device for measuring the voltage (U₁₂) between the output terminals (22, 24), and means for activating the voltage supply unit so that a voltage (U₁₂) is generated between the output terminals (22, 24), and the voltage supply unit is then switched off or switched down to a lower voltage value, and also means for determining the output capacitance from the measurement of the voltage (U₁₂) between the output terminals at at least two instants (t_{A}, t_{B}) during the discharge through the precision resistor (34, 36, 38, 40).

10. A voltage supply device as claimed in claim 9, in which the voltage supply unit is a load-resonant inverter (12), more particularly having a DC voltage output, in which the output capacitance co-determines the resonant frequency.

11. A voltage supply device as claimed in claim 9 or 10, in which at least one terminal device, more particularly cable and/or plug, is provided for connecting a load.

12. An X-ray apparatus comprising a voltage supply device as claimed in one of the claims 9 to 11.

13. An X-ray apparatus as claimed in claim 12, in which a plurality of X-ray tubes (10) are connected to the voltage supply device (12) by cables.
